(19) United States
(12) Patent Application Publication
(10) Pub. No.: US 2022/0343655 A1
(43) Pub. Date: Oct. 27, 2022

(54) METHOD AND SYSTEM FOR FACILITATING SOCIAL DISTANCING

(71) Applicant: TOSHIBA TEC KABUSHIKI KAISHA, Tokyo (JP)

(72) Inventors: Viresh M. SHIROL, Bangalore (IN); Manoj PILLAI, Bangalore (IN); Paresh BHARAMBE, Bangalore (IN)

(73) Assignee: TOSHIBA TEC KABUSHIKI KAISHA, Tokyo (JP)

(21) Appl. No.: 17/541,684

(22) Filed: Dec. 3, 2021

(30) Foreign Application Priority Data
Apr. 24, 2021 (IN) 202141019002

(51) Int. Cl. G06V 20/52; G06V 10/25; G06V 10/764; G08B 21/22; G08B 21/18

(52) U.S. Cl. CPC G06V 20/53; G06V 10/25; G06V 10/764; G08B 21/22; G08B 21/182

(57) ABSTRACT

The present disclosure relates to method and computing system for facilitating social distancing for an area having a crowd of people. The method comprises identifying a plurality of regions in an area. Further, the method comprises classifying each of the regions as either a sparse zone or a crowded zone based on a crowding level of the region. Furthermore, the method comprises controlling an indicator to provide an alert to the people in one of the regions that has been classified as a crowded zone providing information relating to one of the regions that has been classified as a sparse zone.

### CROSS-REFERENCE TO RELATED APPLICATION

This application claims the benefit of and priority to Indian Patent Application No. 202141019002, filed on Apr. 24, 2021, the entire disclosure of which is hereby incorporated by reference herein.

### TECHNICAL FIELD

The present disclosure generally relates to people monitoring. More particularly, the present disclosure relates to a method and system for assisting people to maintain safe distance.

### BACKGROUND

Crowd gatherings at shopping malls, railway stations, retail stores, airports, and the like, can be a source of various risks for individuals. Particularly, the risk is increased when an excessive number of people stay in a single place. When the crowd gatherings exceed a safe limit, people can suffer injuries or even death. Further, the people may wish to follow social distancing to prevent the spread of contagious diseases. The social distancing refers to maintaining a safe distance between the people. The people have to maintain a physical distance with each other and reduce the number of times people come into close contact with each other. Transmission of the contagious diseases can be suppressed by ensuring the social distancing. Hence, there is a need for a system to assist people in maintaining the safe distance.

Conventional techniques to assist people in maintaining the safe distance comprises calculating distance between the people in a video from a top view of the area. Reference points indicating a pre-defined distance threshold is provided to a system. The system provides a number of times people violated the pre-defined distance threshold. Further, the conventional techniques comprise providing information to administrators when the people violate the predefined distance threshold. The information may be provided for example, through a television screen. The conventional techniques do not provide an alert to the people to assist the people in maintaining the safe distance. There is a need for an improved system that can assist the people in maintaining the safe distance.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure discloses a method of facilitating social distancing for an area having a crowd of people that is performed by a one or more processors. The method includes identifying a plurality of regions within an area. Further, the method comprises classifying each of the regions as either a sparse zone or a crowded zone based on a crowding level of the region. Furthermore, the method comprises controlling an indicator to provide an alert to the people in one of the regions that has been classified as a crowded zone and provide information relating to at least one of the regions that has been classified as a sparse zone.

In an embodiment, the present disclosure discloses a computing system for facilitating social distancing for an area having a crowd of people. The computing system includes one or more processors and a memory. The memory stores processor-executable instructions which, on execution, cause the one or more processors to perform a series of functions. The functions include identifying a plurality of regions within an area. The area contains a crowd of people. Further, the functions include classifying each of the regions as either a sparse zone or a crowded zone based on a crowding level of the region. Furthermore, the functions include controlling an indicator to provide an alert to the people in one of the regions that has been classified as a crowded zone and prove information relating to at least one of the regions that has been classified as a sparse zone.

In an embodiment, the present disclosure discloses a non-transitory computer readable medium including instructions stored thereon that when processed by at least one processor cause the at least one processor to perform operations. The operations include identifying a plurality of regions within an area containing a crowd of people. Further, the operations include classifying each of the regions as either a sparse zone or a crowded zone based on a crowding level of the region. Furthermore, the operations include triggering an indicator to provide an alert to the people in at least one of the regions that has been classified as a crowded zone and provide information relating to one of the regions that has been classified as a sparse zone.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1A illustrates an exemplary environment for assisting people to maintain a safe distance, in accordance with some embodiments of the present disclosure;

FIG. 1B shows exemplary regions in an area, in accordance with some embodiments of the present disclosure;

FIG. 2 illustrates an internal architecture of a system for assisting people to maintain a safe distance, in accordance with some embodiments of the present disclosure;

FIG. 3A-3C illustrate exemplary embodiments for monitoring of crowds, in accordance with some embodiments of the present disclosure; and

FIG. 4 shows an exemplary flow chart illustrating method steps for assisting people to maintain a safe distance, in accordance with some embodiments of the present disclosure;

FIGS. 5A and 5B show exemplary illustrations for assisting people to maintain a safe distance, in accordance with some embodiments of the present disclosure; and

FIG. 6 shows a block diagram of a general-purpose computing system for assisting people to maintain a safe distance, in accordance with embodiments of the present disclosure.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure relate to a method and a computing system for assisting people (e.g., individuals) to maintain safe distance. Firstly, one or more regions within an area are identified. A state of each region from the one or more regions is determined. The state of each region is determined to be either a safe zone (e.g., a clear zone, an uncongested zone, a sparse zone, etc.) or a crowded zone (e.g., a congested zone, a packed zone, etc.), based on the crowd of people in the one or more regions. A trigger is provided to an indication system upon determining the state of (e.g., classifying) each region. The indication system provides alerts to people in each region determined to be the crowded zone. The people may move to the safe zone, upon receiving the alert. The present disclosure provisions the indication system to provide the alert in different forms such that the people move to the safe zone. This assists the people to maintain the safe distance in an area.

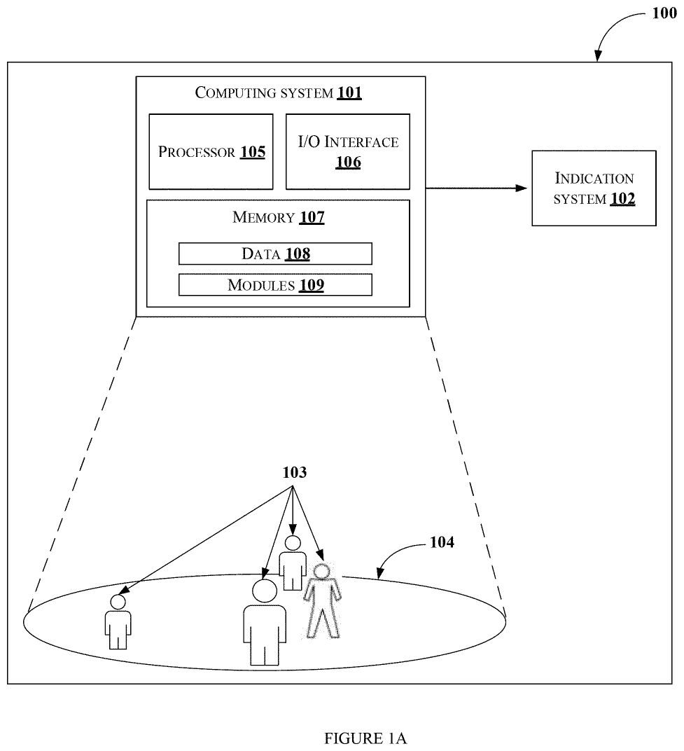

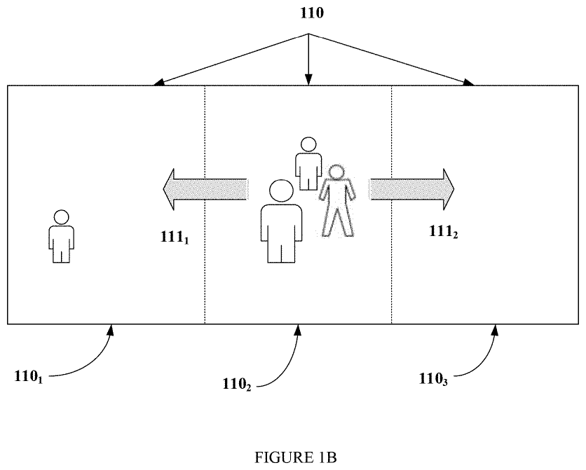

FIG. 1A illustrates an exemplary environment 100 for assisting people to maintain a safe distance (e.g., for assisting individuals to socially distance, for facilitating social distancing), in accordance with some embodiments of the present disclosure. The exemplary environment 100 comprises a computing system 101, an indication system 102, and people 103 (e.g., individuals) in an area 104. The computing system 101 may be configured to assist the people 103 to maintain the safe distance in the area 104. The area 104 may be any area which may be crowded at different times in a day. For example, the area 104 may be a shopping mall, a retail store, an exhibition center, and the like. The area 104 may be a busy or crowded place such as a railway station, a bus station, and the like. The area 104 may be a place where a popular event is organized. The people 103 may be visitors, customers, and the like. The computing system 101 may be configured to identify one or more regions in the area 104. In one embodiment, the identification of the one or more regions may comprise determining the one or more regions based on a crowd in the area 104 (e.g., based on a distribution of the crowd in the area 104). The crowd in the area 104 may be used to determine a large number of the people 103 in the area 104. In another embodiment, the one or more regions may be identified based on pre-stored information related to the area 104.

Further, the computing system 101 may be configured to determine a state of (e.g., classify) each region from one or more regions in the area 104. The state of the one or more regions may be determined to be one of (e.g., classified as one of), a safe zone and a crowded zone. The state of the one or more regions may be determined based on the crowd (e.g., based on a characteristic of the crowd or a crowding level of the region, such as a quantity of people, a density of people, an average distance between people, etc.) in the one or more regions in the area 104. The safe zone may be defined as a region having a lesser number (e.g., a relatively small quantity) of the people 103 and/or distance between the people 103 is greater than a particular distance value (e.g., the density of the people 103 is low). The crowded zone may be defined as a region having greater number (e.g., a relatively large quantity) of the people 103 and/or the distance between the people 103 is lesser than the particular distance value (e.g., the density of the people 103 is high). Reference is made to FIG. 1B illustrating one or more regions 110 in the area 104. Consider the one or more regions 110 in FIG. 1B as one or more regions 110₁, 110₂, and 110₃. The region 110₁ has (e.g., contains) one person. The state of the region 110₁ may be determined to be a safe zone. The region 110₂ has three people with a minimum distance between each other. The state of the region 110₂ may be determined to be a crowded zone. The region 110₃ has no people. The state of the region 110₃ may be determined to be a safe zone.

Further, the computing system 101 may be configured to provide a trigger to the indication system 102 based on the determination of the state of the one or more regions 110. The indication system 102 (e.g., one or more indicators or user interfaces) may be a device that provides indication in form of light, display, audio, and the like. For example, the indication system 102 may be Light Emitting Diodes (LEDs) installed at various locations in the area 104, a laser projector, a television screen, a lightning strip, and the like. The computing system 101 may provide information related to the state of the one or more regions 110 to the indication system 102. The information related to the state of the one or more regions 110 may be provided as control signals. For example, the computing system 101 may provide a control signal valued “0” to the indication system 102 when the state of a region is the safe zone. The computing system 101 may provide a control signal valued “1” to the indication system 102 when the state of a region is the crowded zone. A person skilled in the art will appreciate that the information related to the one or more regions 110 may be communicated to the indication system 102 in any other known methods and is not limited to above-stated methods.

The indication system 102 may be configured to provide an alert (e.g., a notification) to people 103, upon receiving the trigger from the computing system 101. The indication system 102 may provide the alert for each region from the one or more regions 110 determined to be the crowded zone. The alert may be provided for the people to move to the safe zone. Referring to FIGS. 1B, 111₁ and 111₂ represent exemplary directions indicated to the people to move from the crowded zone to the safe zones. The computing system 101 and the indication system 102 may communicate over a communication network (not shown in FIG. 1A and FIG. 1B). The communication network may include, without limitation, a direct interconnection, local area network (LAN), wide area network (WAN), wireless network (e.g., using Wireless Application Protocol), the Internet, etc.

The computing system 101 may include Central Processing Units 105 (also referred as “processing circuitry,” “CPUs,” or “one or more processors 105”), an Input/Output (I/O) interface 106, and a memory 107. In some embodiments, the memory 107 may be communicatively coupled to the processor 105. The memory 107 stores instructions executable by the one or more processors 105. The one or more processors 105 may comprise at least one data processor for executing program components for executing user or system-generated requests. The memory 107 may be communicatively coupled to the one or more processors 105. The memory 107 stores instructions, executable by the one or more processors 105, which, on execution, may cause the one or more processors 105 to assist people 103 to maintain a safe distance in the area 104. In an embodiment, the memory 107 may include one or more modules 109 and data 108. The one or more modules 109 may be configured to perform the steps of the present disclosure using the data 108, to maintain a safe distance in the area 104. In an embodiment, each of the one or more modules 109 may be a hardware unit which may be outside the memory 107 and coupled with the computing system 101. As used herein, the term modules 109 refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide described functionality. The one or more modules 109 when configured with the described functionality defined in the present disclosure will result in a novel hardware. Further, the I/O interface 106 is coupled with the one or more processors 105 through which an input signal or/and an output signal is communicated. For example, the computing system 101 may provide the trigger to the indication system 102 via the I/O interface 106. In an embodiment, the computing system 101, to assist the people 103 to maintain the safe distance in the area 104, may be implemented in a variety of computing systems, such as a laptop computer, a desktop computer, a Personal Computer (PC), a notebook, a smartphone, a tablet, e-book readers, a server, a network server, a cloud-based server and the like.

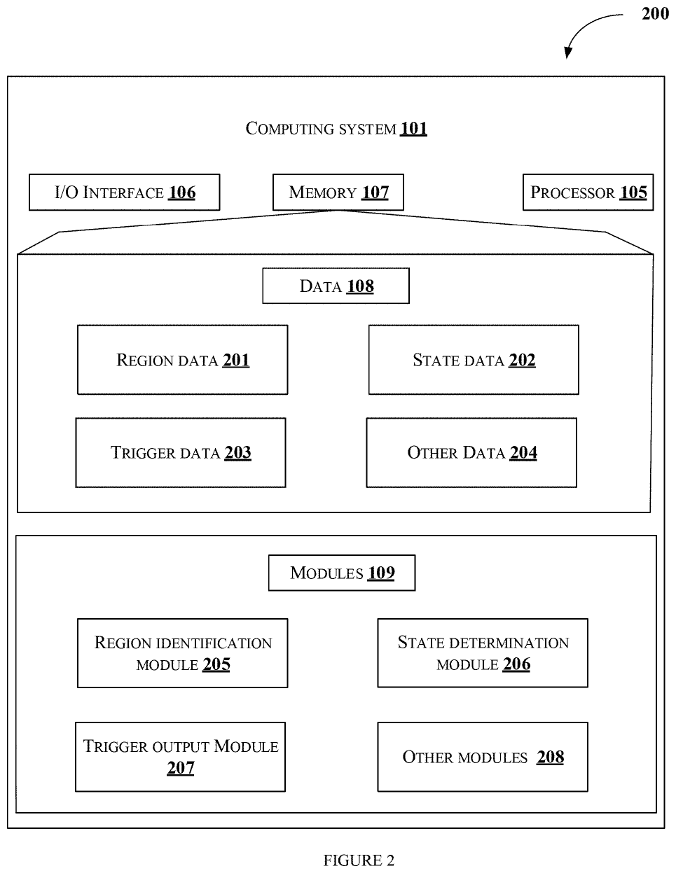

FIG. 2 illustrates an internal architecture 200 of the computing system 101 to maintain the safe distance in the area 104, in accordance with some embodiments of the present disclosure. The computing system 101 may include the one or more processors 105, the memory 107, and the I/O interface 106.

In one implementation, the modules 109 may include, for example, a region identification module 205, a state determination module 206, a trigger output module 207, and other modules 208. It will be appreciated that such aforementioned modules 109 may be represented as a single module or a combination of different modules. In one implementation, the data 108 may include, for example, region data 201, state data 202, trigger data 203, and other data 204.

In an embodiment, the region identification module 205 may be configured to identify the one or more regions 110 in the area 104. In a first embodiment, the region identification module 205 may identify the one or more regions 110 by determining the one or more regions 110 based on a crowd in the area 104 (e.g., based on a distribution of the crowd in the area 104). In a second embodiment, the region identification module 205 may identify the one or more regions 110 based on the pre-stored information related to the area 104.

In the first embodiment, the region identification module 205 may be configured to determine the count (e.g., a quantity or number) of the people 103 in the area 104. The crowd in the area 104 may indicate a count of the people 103 in the area 104 and a distance between the people 103. For example, the count of the people 103 in the area 104 may be 4. Further, the region identification module 205 may be configured to determine an average distance between the people 103 in the area 104. The region identification module 205 may determine a distance between every two persons among the people 103. The average distance between the people 103 may be determined from the distance between every two persons. For example, the average distance may be 2 ft. In another example, the average distance may be 6 ft. The region identification module 205 may determine the crowd from the count of the people 103 and the average distance between the people 103.

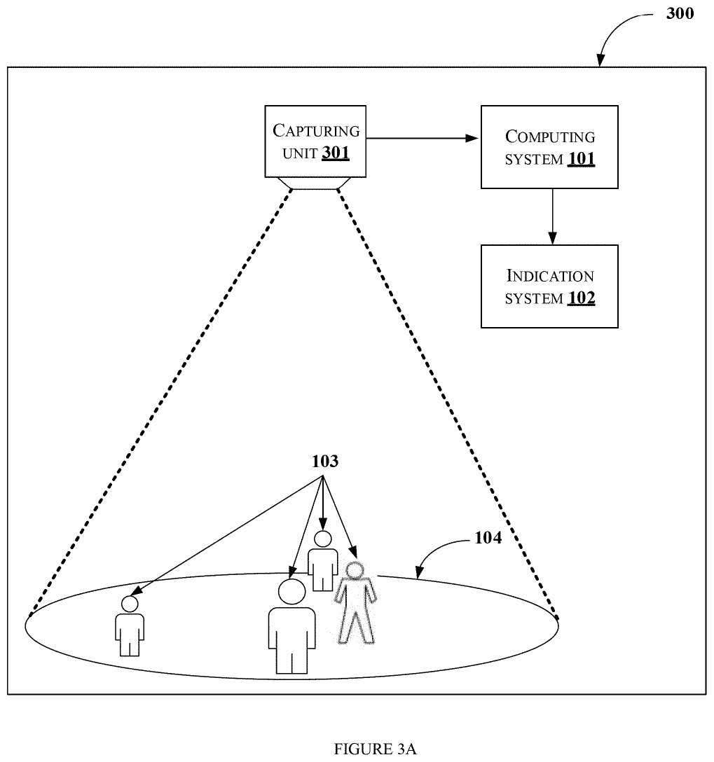

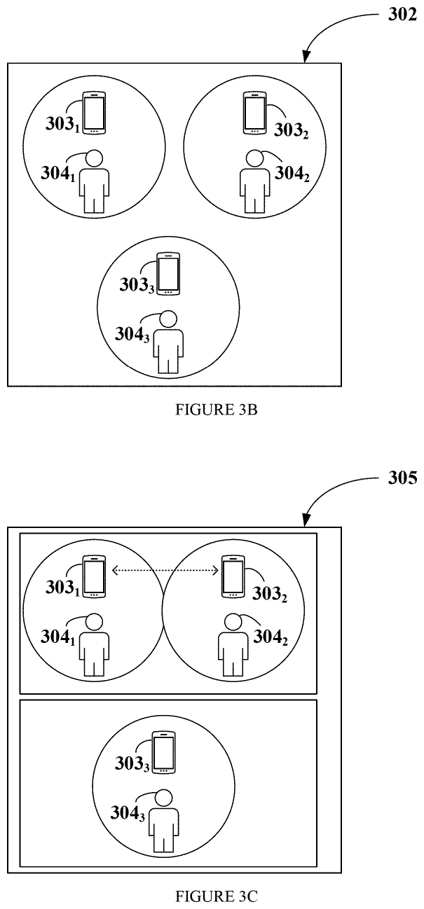

In an embodiment, the region identification module 205 may determine the crowd from an image of the area 104. The region identification module 205 may be associated with a capturing unit 301 (e.g., an imaging device) as shown in FIG. 3A. The capturing unit 301 may be configured to capture the image of the area 104. In an embodiment, the capturing unit 301 may be a camera. A person skilled in art may appreciate that other kinds of capturing unit may be used (e.g., thermal cameras, IR cameras, etc.). The capturing unit 301 may be placed on top of the area 104 such that a focal view of the capturing unit 301 covers entire area. An exemplary focal view of the capturing unit 301 is represented by dotted bold lines in FIG. 3A. A person skilled in the art will appreciate that installation of the capturing unit 301 at other locations such that the entire area is covered. For example, consider the area 104 to be an area on a first floor of a shopping mall. The capturing unit 301 may be installed on a second floor of the shopping mall such that the area on the first floor is covered in the image. In an example, multiple capturing units may be placed at different locations such that an entire area is covered. Further, multiple images captured using the multiple capturing units may be stitched together to generate the image of the entire area.

The region identification module 205 may receive the image of the area 104 from the capturing unit 301. The region identification module 205 may determine the count of the people 103 from the image of the area 104, using computer vision techniques. For example, facial detection techniques may be used to determine the count of the people 103. A person skilled in the art will appreciate that any other known techniques can be used to determine the count of the people 103 from the image and the present disclosure is not limited to the above-mentioned techniques. Further, the region identification module 205 may determine the distance between the people 103 based on parameters related to the capturing unit 301 and the people 103. The parameters related to the capturing unit 301 may comprise focal length of the capturing unit 301, sensor size of the capturing unit 301, and the like. The parameters related to the people 103 may comprise height of a person, distance from the capturing unit 301 to the person, and the like. The region identification module 205 may determine the average distance between the people 103. Further, the region identification module 205 may determine the crowd in the area 104 based on the count of the people 103 and the average distance between the people 103.

In another embodiment, the region identification module 205 may determine the crowd in the area 104 based on short-range communication between devices associated with the people 103 in the area 104. Each person in the area 104 may be associated with a device. For example, each person may be associated with a smartphone. The devices may be enabled one or more short-range technologies. In an embodiment, Bluetooth Low Energy (BLE) may be enabled in the devices. The count of the people 103 may be determined based on the short-range communication between the devices. The distance between the people 103 may be determined based on measurement of strength of signals communicated between the devices. Reference is made example 302 of FIG. 3B, illustrating people 304₁, 304₂, and 304₃. The devices 303₁, 303₂, and 303₃ may be associated with the people 304₁, 304₂, and 304₃, respectively. The devices 303₁, 303₂, and 303₃ may be BLE-enabled devices. Each circle around each of the devices 303₁, 303₂, and 303₃ may represent a Bluetooth range. In another embodiment, Ultra-Wide Band (UWB) may be enabled in the devices. The count of the people 103 may be determined based on the short-range communication between the devices. The distance between the people 103 may be determined based on measurement of time that it takes for a radio wave to pass between the two devices. The region identification module 205 may determine the average distance between the people 103. Further, the region identification module 205 may determine the crowd in the area 104 based on the count of the people 103 and the average distance between the people 103.

Further, the region identification module 205 may be configured to determine the one or more regions 110 based on a crowd in the area 104 (e.g., based on a distribution of a crowd in the area 104). For example, the one or more regions 110 may be dynamically identified based on a number of the people 103 in the area 104 and a farthest distance between the people 103 in the area 104. For example, the one or more regions 110 may be clustered based on groups of the people 103 in the area 104 and distance between the groups. A person skilled in the art will appreciate that any other methods can be used to determine the one or more regions based on the crowd in the area 104 and is not limited to the above-mentioned methods.

In the second embodiment, the region identification module 205 may identify the one or more regions 110 based on the pre-stored information (e.g., predetermined information) related to the area 104. The pre-stored information may comprise a pre-stored image of the area 104. The pre-stored image may be captured when there are no people in the area 104. Empty regions with no obstacles may be identified as the one or more regions. For example, the area 104 may be a department store with aisles. Regions between the aisles may be identified as the one or more regions based on a pre-stored image of the area 104. In another example, ticket counters in a metro station may be the one or more regions. A person skilled in the art may appreciate that other methods to identify the one or more regions may be used and not limited to above-mentioned methods.

Furthermore, the region identification module 205 may be configured to determine the crowd in the one or more regions 110. The determination of the crowd in the one or more regions 110 may be similar to the determination of the crowd in the area 104. The region identification module 205 may communicate the crowd in the one or more regions 110 to the state determination module 206. The count of the people 103 and the average distance between the people 103 may be stored as the region data 201 in the memory 107.

In an embodiment, the state determination module 206 may be configured to receive the region data 201 from the region identification module 205. The state determination module 206 may determine the state of each region from the one or more regions 110 in the area 104. The state may be determined to be one of, the safe zone and the crowded zone. The state may be determined based on the crowd in the one or more regions 110 received from the region identification module 205. The state determination module 206 may determine a region to be the crowded zone, when at least one of, the average distance between the people 103 in the region is less than a pre-defined distance value and the count of people 103 is more than a pre-defined count value. The pre-defined count value may be identified based on dimensions of the one or more regions 110. Further, there may be different pre-defined count value for each region. For example, the pre-defined count value may be 5, and the pre-defined distance value may be 3 ft. In an example, a region may have three people and the average distance between the people 103 may be 2 ft. In such cases, the state of the region may be determined to be the safe zone. In another example, a region may have seven people. The region may be an office cabin. The dimensions of the region may be such that maximum five people may be present in the office cabin to maintain the safe distance. Since the region has seven people, the state of the region may be determined to be the crowded zone.

Reference is made example 305 of FIG. 3C, illustrating people 304₁, 304₂, and 304₃ and the associated devices 303₁, 303₂, and 303₃. The state determination module 206 may determine the state of a region to be the crowded zone, based on the short-range communication between the devices 303₁, 303₂, and 303₃. The devices 303₁, 303₂, and 303₃ may communicate information related to the number of devices and the distance between the devices 303₁, 303₂, and 303₃ to the state determination module 206. The term ‘Bluetooth range’ and the term ‘range’ are used interchangeably in the present description. The state determination module 206 may determine the count of the people 304₁, 304₂, and 304₃ based on the number of devices within the range of other devices. The state determination module 206 may determine the average distance between the people 304₁, 304₂, and 304₃ based the distance between every two devices. FIG. 3C shows the device 303₁ within the range of the device 303₂. The state determination module 206 may determine that the distance between the people 304₁ and 304₂ in a region is less than the pre-defined distance value, from the information related to the distance. The state determination module 206 may determine that the people 304₁ and 304₂ have to space apart in the region. Information related to spacing apart of the people is referred as spacing information hereafter in the description. The spacing information may be stored as the state data 202 in the memory 107. The device 303₃ may be outside the range of the devices 303₁, and 303₁. The state determination module 206 may determine a region including the person 304₃, as the safe zone. In an embodiment, the state determination module 206 may determine the crowd based on the number of devices within range of other devices and the distance between the devices 303₁, 303₂, and 303₃ based on a UWB communication between the devices 303₁, 303₂, and 303₃.

Further, the state determination module 206 may be configured to determine a number of regions from the one or more regions 110, determined to be the crowded zone, to be greater than a pre-determined threshold value. For example, the pre-determined threshold value may be 5. The number of regions with the state as the crowded zone may be determined to control a movement of the people 103 in the area 104. Furthermore, the state determination module 206 may be configured to monitor each region from the one or more regions 110, determined to be the crowded zone, for a pre-determined time. The state determination module 206 may be configured to provide an output when a region from the one or more regions 110 is determined to be crowded for a time exceeding the pre-determined time. For example, 10 people may be standing close to each other at a billing counter in a shopping mall for 5 minutes. The state of the one or more regions 110, the number of the one or more regions 110 determined to be the crowded zone, and the output may be stored as the state data 202 in the memory 107.

In an embodiment, the trigger output module 207 may be configured to receive the state data 202 from the state determination module 206. The state determination module 206 may provide the trigger to the indication system 102, based on the state of each region from the one or more regions 110. In an embodiment, the trigger output module 207 may provide a first trigger when the state of each region from the one or more regions 110 is determined to be the crowded zone. In another embodiment, the trigger output module 207 may provide a first trigger when a region from the one or more regions 110 is associated with the spacing information. In an embodiment, the trigger output module 207 may provide a second trigger when the number of regions from the one or more regions 110 determined to be the crowded zone is greater than the pre-determined threshold value. In an embodiment, the trigger output module 207 may provide a third trigger when a region from the one or more regions 110 is determined to be crowded for a time exceeding the pre-determined time. The indication system 102 may be configured to provide the alert to the people in each region determined to be the crowded zone, upon receiving the first trigger. The alert may be provided for the people to move to the safe zone. The indication system 102 may be configured to provide the alert in form of at least one of, an image on a display, a voice, and a light, upon receiving the first trigger. For example, the indication system 102 may be a laser projector. Each region from the one or more regions 110 determined to be the crowded zone may be projected with laser lights. In an example, the indication system 102 may a drone. The drone may be provided with information related to the one or more regions 110 determined to be the crowded zone. The drone may be configured to provide the alert by moving to each region determined to be a crowded zone. In an embodiment, the indication system 102 may provide the alert indicating the people in a region to space apart, based on the spacing information. The alert may to space apart may be provided so that the safe distance is maintained between the people.

In an embodiment, the indication system 102 may be configured to provide a crowd alert for controlling the movement of the people 103 in the area 104, upon receiving the second trigger. For example, the crowd alert may be provided through a speaker installed at the doors of the area 104. In another example, the crowd alert may be provided to a device associated with security person monitoring the area 104. The security person may control the movement of the people 103 in the area 104. In an embodiment, the indication system 102 may be configured to provide a time alert, upon receiving the third trigger. In an example, the alert based on the first trigger may be provided in form of a display. The time alert may be provided in form of a voice. The first trigger, the second trigger, and the third trigger may be stored as the trigger data 203 in the memory 107.

The other data 204 may store data, including temporary data and temporary files, generated by the one or more modules 109 for performing the various functions of the computing system 101. The one or more modules 109 may also include the other modules 208 to perform various miscellaneous functionalities of the computing system 101. The other data 204 may be stored in the memory 107. It will be appreciated that the one or more modules 109 may be represented as a single module or a combination of different modules.

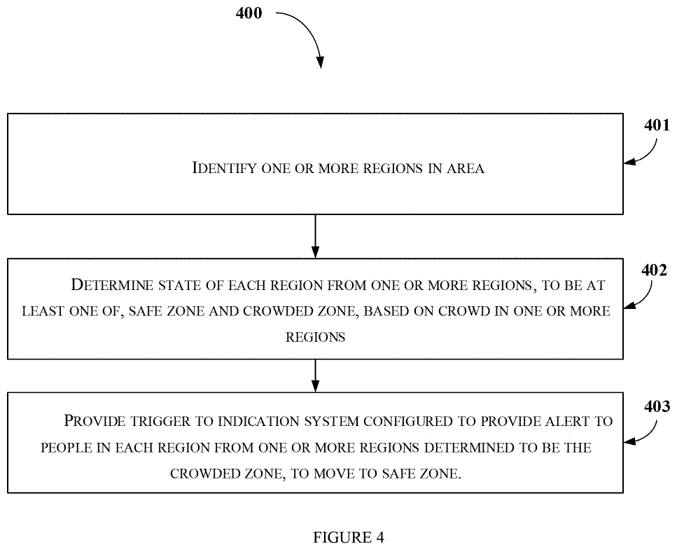

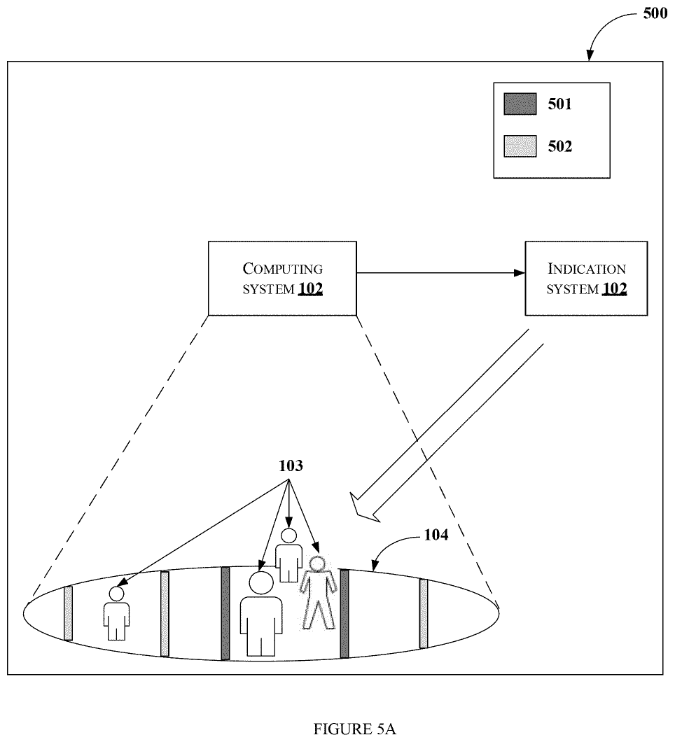

FIG. 4 shows an exemplary flow chart illustrating method steps to assist people 103 to maintain the safe distance in the area 104, in accordance with some embodiments of the present disclosure. As illustrated in FIG. 4, the method 400 may comprise one or more steps. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 401, the computing system 101 may identify the one or more regions 110 in the area 104. In a first embodiment, the computing system 101 may identify the one or more regions 110 by determining (e.g., defining) the one or more regions 110 based on a crowd in the area 104 (e.g., based on a characteristic of the crowd or a crowding level of the region, such as a quantity of people in the crowd, a density of the crowd, and/or an average distance between the people in the crowd). The computing system 101 may determine the crowd (e.g., determine the characteristics of the crowd) from an image of the area 104. In another embodiment, the computing system 101 may determine the crowd in the area 104 (e.g., determine the characteristics of the crowd, the crowding level of the region, etc.) based on short-range communication between devices associated with the people 103 in the area 104. Furthermore, the computing system 101 may be configured to determine the crowd in the one or more regions 110. The computing system 101 may determine the one or more regions 110 based on determination of the crowd in the area 104 (e.g., based on a determination of where the crowd is located within the area 104). For example, the one or more regions 110 may be dynamically identified. The dynamic identification may be performed periodically. In one embodiment, a period to perform the dynamic identification may be constant. In another embodiment, the period may vary based on a time of a day. For example, the period may be short at peak times of the day when the area 104 is crowded such as evening time. The period may be long at other times of the day when the area 104 is less crowded such as afternoon time. In a second embodiment, the computing system 101 may identify the one or more regions 110 based on the pre-stored information related to the area 104.

At step 402, the computing system 101 may determine the state of each region from the one or more regions 110 in the area 104 to be one of, the safe zone and the crowded zone. The computing system 101 may determine the state based on the crowd in the area 104 (e.g., based on a characteristic of the crowd, based on the crowding level of the region). In an embodiment, the computing system 101 may determine the state based on the crowd determined from the image of the area 104. In another embodiment, the computing system 101 may determine the state of each region to be the crowded zone, based on the short-range communication between the devices. Further, the computing system 101 may be configured to determine a number of regions from the one or more regions 110, determined to be the crowded zone, to be greater than a pre-determined threshold value. Furthermore, the computing system 101 may be configured to monitor each region from the one or more regions 110, determined to be the crowded zone, for a pre-determined time.

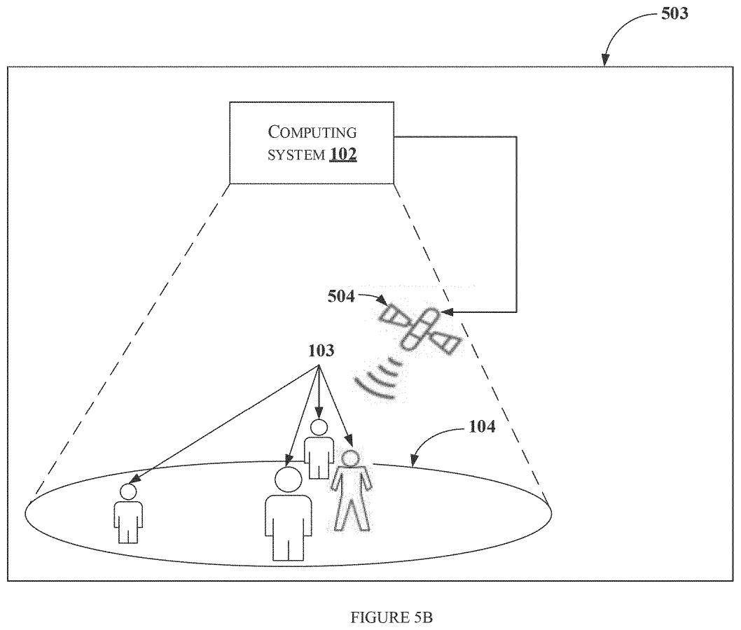

At step 403, the computing system 101 may be provide the trigger to the indication system 102, based on the state of each region from the one or more regions 110. In an embodiment, the computing system 101 may provide a first trigger when the state of each region from the one or more regions 110 is determined to be the crowded zone. In an embodiment, the computing system 101 may provide a second trigger when the number of regions from the one or more regions 110 is determined to be the crowded zone is greater than the pre-determined threshold value. In an embodiment, the computing system 101 may provide a third trigger when a region from the one or more regions 110 is determined to be crowded for a time exceeding the pre-determined time. The indication system 102 may be configured to provide the alert to the people in each region determined to be the crowded zone, upon receiving the first trigger. Referring to example 500 of FIG. 5A, the indication system 102 may be a laser projector (not shown in FIG. 5A). The laser projector may provide the alert by projecting laser lights on the area 104. Different colored lights may be projected to identify the safe zone and the crowded zone. 501 may represent a red color. 502 may represent a green color. Boundaries surrounding a region determined to be the safe zone may be projected with green color lights. Boundaries surrounding a region determined to be the crowded zone may be projected with red color lights. This assists the people to move to the safe zone. Referring to example 503 of FIG. 5B, the indication system 102 may be a drone 504. The drone 504 may be provided with information related to the one or more regions 110 determined to be the crowded zone. The drone 504 may be configured to provide the alert by moving to each region determined to be a crowded zone. The drone providing the alert in form of voice is shown in FIG. 5B.

In an embodiment, the indication system 102 may be configured to provide a crowd alert for controlling the movement of the people 103 in the area 104, upon receiving the second trigger. In an embodiment, the indication system 102 may be configured to provide a time alert, upon receiving the third trigger. Alternate methods to provide the alert may comprise side mounted displays, AR applications, AR headsets, audio indications, floor lighting using tiles with red, green, and blue (RGB) LEDs, lighting strips, and the like.

### Computer System

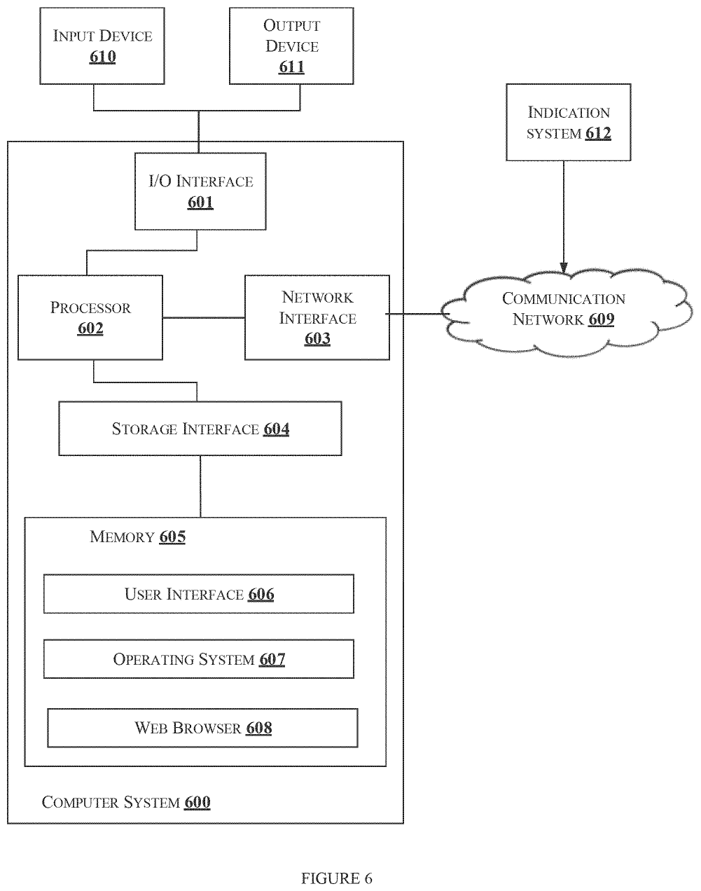

FIG. 6 illustrates a block diagram of an exemplary computer system 600 for implementing embodiments consistent with the present disclosure. In an embodiment, the computer system 600 may be used to implement the computing system 101. Thus, the computer system 600 may be used to assist the people 103 to maintain the safe distance in the area 104. In an embodiment, the computer system 600 may provide the trigger to the indication system 612 over the communication network 609. The computer system 600 (e.g., a controller, control circuitry, a control circuit, etc.) may comprise a Central Processing Unit 602 (also referred as “CPU” or “processor”). The processor 602 may comprise at least one data processor. The processor 602 may include specialized processing units such as integrated system (bus) controllers, memory management control units, floating point units, graphics processing units, digital signal processing units, etc.

The processor 602 may be disposed in communication with one or more input/output (I/O) devices (not shown) via I/O interface 601. The I/O interface 601 may employ communication protocols/methods such as, without limitation, audio, analog, digital, monoaural, RCA, stereo, IEEE (Institute of Electrical and Electronics Engineers)-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 601, the computer system 600 may communicate with one or more I/O devices. For example, the input device 610 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 611 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The computer system 600 is connected to the indication system 612 through a communication network 609. The processor 602 may be disposed in communication with the communication network 609 via a network interface 603. The network interface 603 may communicate with the communication network 609. The network interface 603 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 609 may include, without limitation, a direct interconnection, local area network (LAN), wide area network (WAN), wireless network (e.g., using Wireless Application Protocol), the Internet, etc. The network interface 603 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 609 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 602 may be disposed in communication with a memory 605 (e.g., RAM, ROM, etc. not shown in FIG. 6) via a storage interface 604. The storage interface 604 may connect to memory 605 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 605 may store a collection of program or database components, including, without limitation, a user interface 606, an operating system 607, web browser 608 etc. In some embodiments, computer system 600 may store user/application data, such as, the data, variables, records, etc., as described in this disclosure. Such databases may be implemented as fault-tolerant, relational, scalable, secure databases such as Oracle® or Sybase®.

The operating system 607 may facilitate resource management and operation of the computer system 600. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system 600 may implement the web browser 608 stored program component. The web browser 608 may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 608 may utilize facilities such as AJAX™, DHTML™, ADOBE® FLASH™, JAVASCRIPT™, JAVA™, Application Programming Interfaces (APIs), etc. In some embodiments, the computer system 600 may implement a mail server (not shown in Figure) stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 600 may implement a mail client stored program component. The mail client (not shown in Figure) may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

Embodiments of the present disclosure assist people to maintain the safe distance in an area by providing an alert in different forms such that the people move to a safe zone. Further, the present disclosure provides alerts when the people are crowded at a region for a longer time (e.g., an extended period of time). Hence, the present disclosure provides methods to assist social distancing between people, thereby suppressing transmission of the contagious diseases.

In the present disclosure, alerts are provided for controlling a movement of the people in the area. Hence, the present disclosure provides methods to avoid over-crowding of the area.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4 show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method of facilitating social distancing for an area having a crowd of people, the method comprising:
identifying, by one or more processors, a plurality of regions within the area;
classifying, by the one or more processors, each of the regions as either a sparse zone or a crowded zone based on a crowding level of the region; and
controlling, by the one or more processors, an indicator to provide an alert to the people in at least one of the regions that has been classified as a crowded zone and provide information relating to one of the regions that has been classified as a sparse zone.

2. The method of claim 1, wherein identifying the plurality of regions comprises at least one of:
identifying the plurality of regions based on a distribution of the crowd throughout the area; or
identifying the plurality of regions based on pre-stored information related to the area.

3. The method of claim 1, further comprising:
determining, by the one or more processors, a quantity of the people in each region;
determining, by the one or more processors, an average distance between the people in each region; and
determining, by the one or more processors, the crowding level of each region based on the quantity of the people in the region and the average distance between the people in the region.

4. The method of claim 3, wherein the crowding level of each region is determined based on an image of the area received from an image capture device operatively coupled to the one or more processors.

5. The method of claim 3, wherein the crowding level of each region is determined based on one or more short-range communications between devices associated with the people in the area.

6. The method of claim 1, wherein the one or more processors is configured to classify each region as a crowded zone in response at least one of (a) a determination that an average distance between the people in the region less than a pre-defined distance value or (b) a determination that a quantity of the people in the region is more than a pre-defined quantity.

7. The method of claim 1, wherein the indicator is configured to provide the alert as at least one of (a) an image on a display, (b) a voice, or (c) a light.

8. The method of claim 7, wherein the indicator includes a drone configured to provide the alert by moving to each region classified as a crowded zone.

9. The method of claim 1, further comprising:
providing a crowd alert for controlling a movement of the people in the area in response to a determination that a number of the regions that have been classified as crowded zones is greater than a pre-determined threshold value.

10. The method of claim 1, further comprising:
monitoring, for a pre-determined period of time, each of the regions that have been classified as crowded zones; and
providing a time alert to the people in a first region of the plurality of regions in response to a determination that the first region has been classified as a crowded zone for at least the pre-determined period of time.

11. A computing system for facilitating social distancing for an area having a crowd of people, the computing system comprising:
one or more processors; and
a memory, wherein the memory stores processor-executable instructions, which, on execution, cause the one or more processors to:
identify a plurality of regions within an area, the area containing a crowd of people;
classify each of the regions as either a sparse zone or a crowded zone based on a crowding level of the region; and
control an indicator to provide an alert to the people in at least one of the regions that has been classified as a crowded zone and provide information relating to one of regions that has been classified as a sparse zone.

12. The computing system of claim 11, wherein the processor-executable instructions cause the one or more processors to identify the plurality of regions by at least one of:
identifying the plurality of regions based on a distribution of the crowd throughout the area; or
identifying the plurality of regions based on pre-stored information related to the area.

13. The computing system of claim 11, wherein the processor-executable instructions cause the one or more processors to:
determine a quantity of the people in each region;
determining an average distance between the people in each region; and
determining the crowding level of each region based on the quantity of the people in the region and the average distance between the people in the region.

14. The computing system of claim 13, wherein the processor-executable instructions cause the one or more processors to determine the crowding level of each region based on an image of the area received from an image capture device operatively coupled to the computing system.

15. The computing system of claim 13, wherein the processor-executable instructions cause the one or more processors to determine the crowding level of each region based on one or more short-range communications between devices associated with the people in the area.

16. The computing system of claim 11, wherein the processor-executable instructions cause the one or more processors to classify each region as a crowded zone in response to at least one of (a) a determination that an average distance between the people in the region is less than a pre-defined distance value or (b) a determination that a quantity of the people in the region is more than a pre-defined quantity.

17. The computing system of claim 11, wherein the indicator is configured to provide the alert as at least one of (a) an image on a display, (b) a voice, or (c) a light.

18. The computing system of claim 17, wherein the indicator includes a drone configured to provide the alert by moving to each region classified as a crowded zone.

19. The computing system of claim 11, wherein the processor-executable instructions cause the one or more processors to:
provide a crowd alert for controlling a movement of the people in the area in response to a determination that a number of the regions that have been classified as crowded zones is greater than a pre-determined threshold value.

20. The computing system of claim 11, wherein the processor-executable instructions cause the one or more processors to:
monitor, for a pre-determined period of time, each of the regions that have been classified as crowded zones; and
provide a time alert to people in a first region of the plurality of regions in response to a determination that the first region has been classified as a crowded zone for at least the pre-determined period of time.

21. A non-transitory computer readable medium including instructions stored thereon that, when processed by at least one processor, cause the at least one processor to perform operations comprising:
identifying a plurality of regions within an area containing a crowd of people;
classifying each of the regions as either a sparse zone or a crowded zone based on a crowding level of the region; and
triggering an indicator to provide an alert to the people in at least one of the regions that has been classified as a crowded zone and provide information relating to one of the regions that has been classified as a sparse zone.

22. The non-transitory computer readable medium of claim 21, wherein identifying the plurality of regions comprises at least one of:
identifying the plurality of regions based on a distribution of the crowd throughout the area; and
identifying the plurality of regions based on pre-stored information related to the area.

23. The non-transitory computer readable medium of claim 21, wherein the crowd in the area and the plurality of regions is determined by:
determining a quantity of the people in each region;
determining an average distance between the people in each region; and
determining the crowding level of each region based on the quantity of the people in the region and the average distance between the people in the region.

24. The non-transitory computer readable medium of claim 23, wherein the crowding level of each region is determined based on an image of the area received from an image capture device.

25. The non-transitory computer readable medium of claim 23, wherein the crowding level of each region is determined based on one or more short-range communications between devices associated with the people in the area.

26. The non-transitory computer readable medium of claim 21, wherein each region is classified as a crowded zone in response to at least one of (a) a determination that an average distance between the people in the region is less than a pre-defined distance value or (b) a determination that a quantity of the people in the region is more than a pre-defined quantity.

27. The non-transitory computer readable medium of claim 21, wherein the indicator is configured to provide the alert as at least one of (a) an image on a display, (b) a voice, or (c) a light.

28. The non-transitory computer readable medium of claim 27, wherein the indicator includes a drone configured to provide the alert by moving to each region classified as a crowded zone.

29. The non-transitory computer readable medium of claim 21, wherein the operations further comprise:
providing a crowd alert for controlling a movement of the people in the area in response to a determination that a number of the regions that have been classified as crowded zones is greater than a pre-determined threshold value.

30. The non-transitory computer readable medium of claim 21, wherein the operations further comprise:
monitoring, for a pre-determined period of time, each of the regions that have been classified as crowded zones; and
providing a time alert to the people in a first region of the plurality of regions in response to a determination that the first region has been classified as a crowded zone for at least the pre-determined period of time.
